(19) United States
(12) Patent Application Publication
(10) Pub. No.: US 2018/0063088 A1
(43) Pub. Date: Mar. 1, 2018

(54) HYPERVISOR NETWORK PROFILES TO FACILITATE VPN TUNNEL

(71) Applicant: AirWatch LLC, Atlanta, GA (US)

(72) Inventor: Adam Michael Hardy, Alpharetta, GA (US)

(21) Appl. No.: 15/254,070

(22) Filed: Sep. 1, 2016

(51) Int. Cl. H04L 29/06; H04L 12/46; G06F 9/455

(52) U.S. Cl. CPC H04L 63/0272; H04L 12/4641; H04L 63/0823; G06F 9/45558; H04L 63/029; H04L 12/4633

(57) ABSTRACT

A system can include a host device that execute a virtual machine execution environment. A hypervisor network profile can be associated with the hypervisor of the virtual machine execution environment. The hypervisor network profile can include virtual private network (VPN) configuration profiles that can instruct the hypervisor to route network traffic from a virtual machine to a VPN tunnel server according to the VPN configuration parameters.

### BACKGROUND

Virtual machines can be a convenient way for information technology (IT) departments to deploy pre-configured and secure computing resources to users of an enterprise computing environment. Some companies allow users to obtain virtual machines that are executed within a virtual machine execution environment on their personal machines or machines that are owned or managed by the enterprise. Various enterprise resources, such as network shares, identity or authentication servers, domain controllers, or other computers, might be segregated from the public internet on a private or internal network. Access to these resources can be restricted from an internal network by a firewall for security purposes.

In some instances, a virtual private network (VPN) capability can be provided that allows machines that are external to the private network to be virtually seated within the private network so that access to restricted enterprise resources is possible. In many cases, the VPN capability is provided by establishing a VPN tunnel server through which a machine can “tunnel” into the private network from the public internet. In this scenario, authentication of the user and/or a machine from which a user is accessing the VPN tunnel server is necessary. Additionally, a user might be required to install or configure a VPN client on their machines in order to access the VPN.

In the case of a virtual machine configured to access enterprise resources that are behind a firewall and on the private network, a user might be required to install or configure a VPN client on a host machine in which the virtual machine execution environment is executed, connect to the VPN tunnel server using the VPN client, and then execute the virtual machine.

Therefore, the security requirement of information technology departments who wish to maintain a firewall where network resources are secured can impose an educational burden on users who are required to learn how to use a VPN client.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example of a networked environment.

FIG. 2 shows a sequence diagram illustrating an example of component interaction.

FIG. 3 shows a sequence diagram illustrating an example of component interaction.

FIG. 4 shows a flowchart illustrating an example of functionality implemented by a hypervisor management component.

FIG. 5 shows a flowchart illustrating an example of functionality implemented by hypervisor executed on a host device.

### DETAILED DESCRIPTION

The present disclosure relates to the management of virtual machines that can be deployed to computing devices associated with users of an enterprise. In one example, a host computing device can execute a virtual machine execution environment, which can in turn execute one or more virtual machines. In one example, the host computing device can be a client device that is enrolled and managed by a management service associated with an enterprise. To this end, the host computing device can execute a host management component, which can monitor conditions associated with the host device. However, in many examples of the disclosure, the host computing device need not be a managed device and need not execute a host management component.

In one scenario, the host management component can determine whether the host device, a virtual machine executed therein, or a hypervisor facilitating execution of the virtual machine violate various compliance rules. If the host device, the virtual machine, or the hypervisor violate a compliance rule, the host management component can perform various remedial actions. For example, the host management component can take action against or modify a condition of the host device, the virtual machine, or the hypervisor.

A hypervisor management component can also assess the compliance and operating conditions of a hypervisor component of a virtual machine execution environment. Additionally, a hypervisor management component can receive and install profiles (e.g., configuration files, XML code) from a remotely executed hypervisor management service. The profiles can govern the behavior and execution of the hypervisor and instruct the hypervisor to enforce certain policies against one or more virtual machines executed in a virtual machine execution environment.

In examples of this disclosure, the hypervisor management component can receive and enforce hypervisor network profiles that specify how network traffic should be routed or encapsulated with one or more security layers without requiring any routing or security logic to be installed or configured on a virtual machine. In one example, the hypervisor network profile can provide virtual private network (VPN) configuration parameters, and the hypervisor can be embedded with logic that routes network traffic to a VPN tunnel server so that a virtual machine is tunneled onto a private network. In another example, access to the VPN tunnel server by the virtual machine can be granularly restricted such that communications to and/or from particular applications executed by the virtual machine, communications to and/or from particular network end-points, and communications containing and/or not containing particular content are routed through the VPN tunnel to the VPN tunnel server. To this end, a profile can specify whether one or more of the following should be routed through the VPN tunnel: inbound communications to a particular application, outbound communications to a particular application, inbound communications from a particular network end-point, outbound communications to a particular network end-point, communications including particular content, and communications that do not include particular content.

The hypervisor network profile and hypervisor can provide this functionality without requiring that a VPN client be installed or configured by a user on the host device or on a virtual machine. As a result, the hypervisor management component and hypervisor can improve the functioning of computer systems and networks by allowing a virtual machine to send and receive data as if it were connected to an enterprise private network while reducing the configuration and user-education burden imposed by previous solutions. Additionally, the hypervisor management component and hypervisor can improve the functioning of computer systems and networks by providing granular access to the enterprise private network such that only particular communications are routed through a VPN tunnel into the enterprise private network, as described herein.

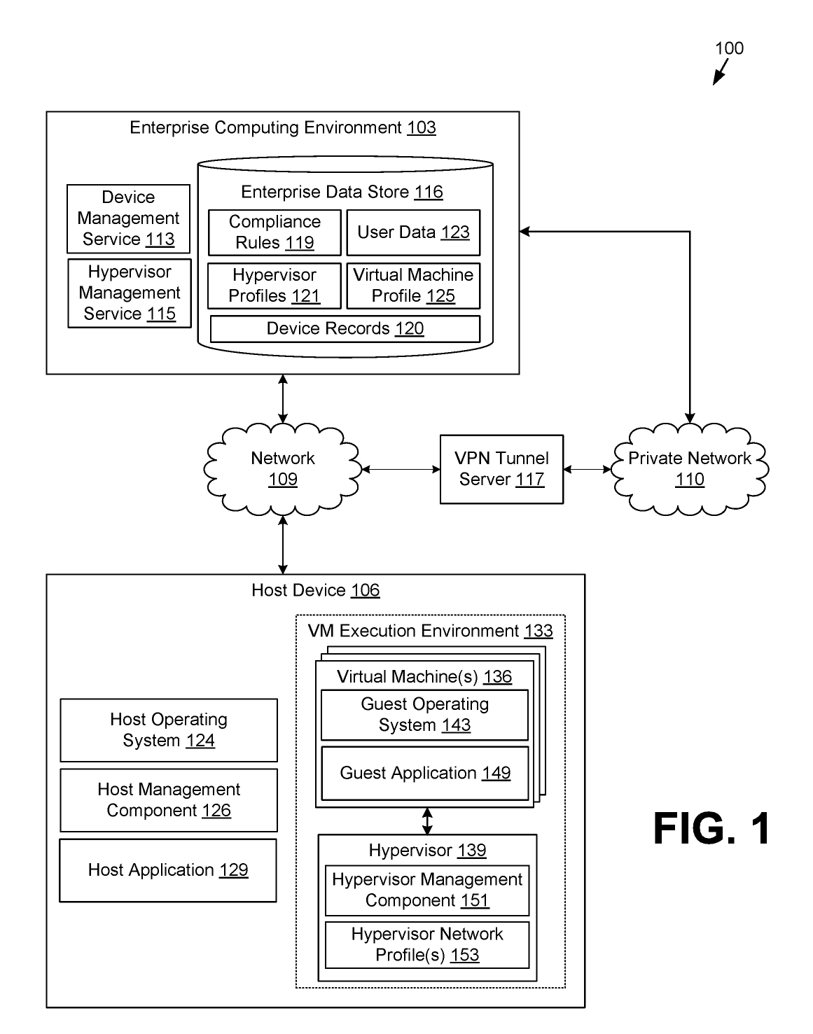

With reference to FIG. 1, shown is an example of a networked environment 100. The networked environment 100 can include an enterprise computing environment 103, a host device 106, and a VPN tunnel server 117 in data communication through a network 109. The network 109 can include a public network, such as the Internet, one or more intranets, extranets, wide area networks (WANs), local area networks (LANs), wired networks, wireless networks, or any combination of two or more such networks. The network 109 can include satellite networks, cable networks, Ethernet networks, cellular networks, and telephony networks. The private network 110 can include a network that might be situated or secured behind a firewall or otherwise segregated from the network 109. In one example, the private network 110 can include a corporate network that is protected from the network 109 behind a firewall. The VPN tunnel server 117 and the enterprise computing environment 103 can have access to the private network 110, as they can, in some scenarios, act as conduits to resources attached to the private network 110, such as data or other nodes attached to the private network 110.

The enterprise computing environment 103 can be a computing system operated by one or more enterprises, such as a business, educational institution, government, or other organization. The enterprise computing environment 103 can include a computing device, such as a server computer, that can provide computing capabilities. Alternatively, the enterprise computing environment 103 can include multiple computing devices arranged in one or more server banks or computer banks. For examples in which the enterprise computing environment 103 includes multiple computing devices, the computing devices can be located in a single installation, or the computing devices can be distributed among multiple different geographical locations.

In some examples, the enterprise computing environment 103 can include computing devices that together form a hosted computing resource or a grid computing resource. In other examples, the enterprise computing environment 103 can operate as an elastic computing resource for which the allotted capacity of computing-related resources, such as processing resources, network resources, and storage resources, can vary over time. In other examples, the enterprise computing environment 103 can include or be operated as one or more virtualized computer instances that can be executed in order to perform the functionality that is described herein.

The enterprise computing environment 103 can include various systems. For example, the enterprise computing environment 103 can include a management service 113 that can monitor and manage the operation of host devices 106 or other computing devices that are associated with the enterprise that operates the enterprise computing environment 103. In some examples, the management service 113 can manage and oversee the operation of multiple host devices 106 enrolled as managed devices that are managed by the management service 113. The management service 113 can also provide the host devices 106 with access to email, calendar data, contact information, and other resources associated with the enterprise. As noted above, examples of this disclosure do not require that all host devices 106 be enrolled as managed devices.

The enterprise computing environment 103 can also include an enterprise data store 116. The enterprise data store 116 can be representative of multiple enterprise data stores 116 accessible by components in the networked environment 100. The enterprise data store 116 can store various data associated with the enterprise computing environment 103. For example, the enterprise data store 116 can store compliance rules 119, device records 120, hypervisor profiles 121, user profiles 123, and virtual machine (VM) profiles 125.

A device record 120 can include various security settings selected for enforcement on a host device 106 that is enrolled with the management service 113. Accordingly, a device record 120 can include a device identifier associated with a client device, such as the host device 106, one or more device certificates, a compliance status, and other data. In some examples, a device record 120 can also identify a user associated with a particular host device 106. A compliance status stored in the device record 120 can indicate whether a particular host device 106 is in compliance with one or more compliance rules 119.

A device record 120 can also store other device specific information, such as a device type, operating system type or version, applications that are required or optional for the device, or an enrollment status of the device. In this scenario, the device record 120 can also indicate whether a managed device is a computing device or a peripheral device, such as a printer, scanner, or other device that can be deployed in an environment and associated with a record in a directory service. The device record 120 might also include or be associated with a command queue through which the management service 113 can manage an enrolled host device 106.

In one example, the management service 113 can cause a host management component 126 to control use of the host device 106 or provision data to the host device 106 through use of a command queue provided by the management service 113. The management service 113 can store commands in a command queue associated with a particular host device 106 and can configure the host management component 126 executed by the host device 106 to retrieve the contents of the command queue. In one example, the host management component 126 can be configured to retrieve the contents of the command queue on a configured interval, such as every four hours, or upon occurrence of a certain event, such as upon detecting an unauthorized application executed by the host device 106, a connection by the host device 106 to the network 109, or a boot up of the host device 106. In any case, the host management component 126 can retrieve the contents of the command queue by checking in with the management service 113 and requesting the contents of the command queue. In one example, the contents of the command queue can include a command that the host management component 126 causes to be executed on the host device 106. To this end, a command can cause one or more files to be deleted from a memory of the host device 106, cause the host device 106 to be placed in a “locked” mode, or cause the host device 106 to activate, deactivate, or remove one or more profiles (e.g., VPN, MDM profile) from the host device 106.

In another example, the contents of the command queue can include a resource or a client application that the host management component 126 causes to be installed on the host device 106, which the host device 106 may access through a specified uniform resource locator (URL).

Various compliance rules 119 can be enforced by the management service 113 on a host device 106 enrolled as a managed device. In one example, the command queue can be leveraged to enforce compliance rules 119 on an enrolled host device 106. Compliance rules 119 can be based on time, geographical location, or device and network properties. For instance, the host device 106 can satisfy a compliance rule 119 when the host device 106 is located within a particular geographic location. The host device 106 can satisfy a compliance rule 119 in other examples when the host device 106 is in communication with a particular local area network, such as a particular local area network that is managed by the computing environment 203. Furthermore, a compliance rule 119 in another example can be based upon the time and date matching specified values.

A compliance rule 119 can specify that a host device 106 is required to be off or in a low power “sleep” state during a specified time period. Another compliance rule 119 can specify that a host device 106 is required to be on or in a normal operation “awake” state during a specified time period. As another example, a compliance rule 119 can specify that a host device 106 is prohibited from rendering content that has been designated as confidential.

Other examples of compliance rules 119 include a rule that specifies whether a host device 106 is compromised or “jailbroken.” For example, a host device 106 can have hardware or software protections in place that prevent unauthorized modifications of the host device 106. If these protections are violated, overridden or bypassed, the host device 106 can be considered out of compliance. As another example, a compliance rule 119 can specify that the host device 106 is required to prompt a user for a password or personal identification number (PIN) in order to unlock the device.

A compliance rule 119 can also require that the host device 106 have device encryption enabled, where data stored on the device is stored in an encrypted form. The data can be encrypted by a device certificate. A compliance rule 119 can also specify that the host device 106 is enrolled with the management service 113 as a managed device, causing the management service 113 to have device administrator privileges over the host device 106 to control and/or configure one or more functions of the host device 106 as described herein. Another compliance rule 119 can specify that the user is required to accept the terms of service that are presented by the host management component 126 on the host device 106. As another example, a compliance rule 119 can specify that the host management component 126 is required to periodically communicate or “check-in” with the management service 113 to report on its status. If a threshold amount of time has elapsed since the previous check-in of the host device 106, the device can be considered to have violated this compliance rule 119.

Another compliance rule 119 can specify that a host device 106 run one of a specified variants or versions of a particular operating system. A compliance rule 119 can also specify that a particular manufacturer manufacture an enrolled device, or that an enrolled device have a particular manufacturer identifier. Another compliance rule 119 can specify that an enrolled device be a particular model name or model number. A host device 106 can also be considered out of compliance if the device is in a data roaming mode or has used a threshold amount of a periodic network data usage allowance.

A compliance rule 119 can also identify a list of required applications that must be installed on the host device 106 or a list of forbidden applications that cannot be installed on the host device 106. The host management component 126 can remove a forbidden application or install a missing required on application on the host device 106 in response to detecting a violation of such a compliance rule 119. A compliance rule 119 can also require the presence of a mobile device management (MDM) profile, an MDM storage area, an application profile, and/or a configuration profile. The host management component 126 can obtain and store missing required data or containers on the host device 106 in response to detecting a violation of such a compliance rule 119.

In some examples, a virtual machine 136 can execute a management component that exercises control and management of the operation of the virtual machine 136 within the virtual machine execution environment 133. In this way, any of the above examples of compliance rules 119 can be enforced on virtual machine 136 within a host device 106. Alternatively, a management component that exercises control and management over the host device 106 or hypervisor 139 can enforce compliance rules 119 on a virtual machine 136.

User data 123 contains information about users of an enterprise. User data 123 can include profile information about a user, authentication information about a user, applications that are installed on host devices 106 or virtual machines 136 associated with the user, and other user information. For example, user data 123 can include information about host devices 106 and virtual machines 136 that are associated with a user account of the user, enterprise resources to which a particular user has access, such as email, calendar data, documents, media, applications, network sites, or other resources. The user data 123 can also identify one or more user groups of which a particular user is a member, which can in turn define the access rights of the user to one or more enterprise resources as well as identify which applications should be deployed to a host device 106 or virtual machine 136 associated with the user. Membership in a user group can also define the compliance rules 119 to which a particular user is subject. For instance, a compliance rule 119 can include a whitelist or a blacklist that specifies whether particular users or groups of users are authorized to perform various functionalities, such as installing or executing a particular application.

Hypervisor profiles 121 contain information about hypervisors 139 or virtual machine execution environments 133 that are deployed to various host devices 106 by the enterprise and managed by the hypervisor management component 115. The hypervisor profile 121 can contain information about a hypervisor network profile 151, which can be provisioned to a hypervisor 139 to cause the hypervisor 139 to apply specified routing or VPN parameters for one or more virtual machines 136 executed by virtual machine execution environments 133. In one example, a hypervisor profile 121 can be generated for each instance of a virtual machine execution environment 133 that is deployed to a host device 106 by the hypervisor management component 115. The hypervisor profile 121 can be associated with a particular user account and include VPN authentication parameters or a certificate with which access to the private network 110 can be authenticated. The hypervisor profile 121 can also identify a network address of the VPN tunnel server 117 associated with the private network 110. The hypervisor profile 121 can further identify a particular VPN protocol employed by the VPN tunnel server 117 to grant access to the private network 110.

The hypervisor profile 121 can also include identifiers or signatures for the virtual machines 136 that are deployed to a particular virtual machine execution environment 133. In this way, a hypervisor profile 121 can define policies or configuration parameters for specific virtual machines 136, which can be user and/or device specific (as individually specified or by virtue of a user or device belonging to a particular group, as described herein). For example, VPN configuration parameters can be assigned to a particular virtual machine 136 executed in the virtual machine execution environment 133. Further, a hypervisor profile 121 can specify that access to the VPN tunnel server by a virtual machine should be granularly restricted such that communications to and/or from particular applications executed by the virtual machine, communications to and/or from particular network end-points, and communications containing and/or not containing particular content are routed through the VPN tunnel to the VPN tunnel server. To this end, a hypervisor profile 121 can specify whether one or more of the following should be routed through the VPN tunnel: inbound communications to a particular application, outbound communications to a particular application, inbound communications from a particular network end-point, outbound communications to a particular network end-point, communications including particular content, and communications that do not include particular content.

Virtual machine profiles 125 can be disk images or virtual machine parameters from which a virtual machine 136 can be generated and deployed to a virtual machine execution environment 133. The virtual machine profiles 125 can be tailored by an IT administrator to include applications and/or services for a particular user of the enterprise. For example, the virtual machine profile 125 for a particular user can be pre-configured with his or her user credentials or an authentication token so that, when executed by the virtual machine execution environment 133 as a virtual machine 136, the virtual machine 136 includes the applications and services that the user requires. The applications and services that the user requires can be defined by the user profile corresponding to the user within the enterprise computing environment 103.

The VPN tunnel server 117 can represent one or more tunnel servers that can be employed to terminate a tunnel connection from a host device 106 to the private network 110. The VPN tunnel server 117 can implement one or more VPN protocol that provide secure connectivity between a machine external to the private network 110 and other nodes on the private network 110. In other words, the VPN tunnel server 117 can provide a network tunnel connection that allows machines external to the private network 110, such as virtual machines 136 executing on the host device 106, to be seated on the private network 110 over a secure VPN tunnel through the network 109, which can be a public network such as the Internet. For instance, the VPN tunnel can employ an encrypted communicational channel (e.g., TLS) to prevent unauthorized access to communications between the host device 106 and other computing devices connected to the private network 110.

The host device 106 can be representative of multiple client devices that can be coupled to the network 109. The host device 106 can include a processor-based computer system, such as a desktop computer, a laptop computer, a personal digital assistant, a mobile phone, or a tablet computer.

The host device 106 can include a host operating system 124, the host management component 126, a host application 129, and a virtual machine execution environment 133. The host operating system 124 can manage hardware and software resources in the host device 106. The host operating system 124 can also provide various services, such as an interprocess communication service that can facilitate various components within the host device 106 communicating and sharing data with each other.

The host application 129 can include a set of computer programs that can perform various functionalities when executed by the host device 106. For example, the host application 129 can be a word processing application, a video and image rendering application, or an email client. The user of the host device 106 can operate and interact with the host application 129 to perform various functionalities.

As noted above, the host management component 126 can monitor activity and settings in the host device 106, including activity and settings of components in the virtual machine execution environment 133, and determine whether compliance rules 119 associated with the host device 106 are satisfied. In some examples, the host management component 126 can parse a data object that describes the state of and settings for components in the host device 106 to determine whether compliance rules 119 are satisfied. In other examples, the host management component 126 can communicate with the management service 113 or other components in the host device 106 to determine whether the management service 113 or the other components determine that compliance rules 119 are satisfied. The host management component 126 can also communicate with various components in the host device 106, such as components in the virtual machine execution environment 133.

In some examples, the host management component 126 can be a portion of the host operating system 124. In another example, the host management component 126 can operate in the application layer of the host device 106. For instance, the host management component 126 can operate as a dedicated application that can monitor and manage data, software components, and hardware components associated with the host device 106.

In some examples, at least a portion of the host management component 126 can be included in the host application 129. To this end, the enterprise computing environment 103 can provide a software development kit (SDK) that a developer of the host application 129 can use to insert security libraries and other components of the host management component 126 into the host application 129. In another approach, the management service 113 or the developer of the host application 129 can incorporate libraries into the host application 129 through a process known as “wrapping.” To wrap a host application 129, the developer or management service 113 can decompile the host application 129 and then insert the libraries into the decompiled host application 129. The developer or management service 113 can then recompile the host application 129 with the added security libraries.

In some examples, a guest application 149 can also be incorporated with the functionalities of the host management component 126 through the wrapping process. In either scenario, a wrapped application can be identified as an application whose traffic is routed through a VPN tunnel to the VPN tunnel server 117 while applications that are not wrapped applications can have their traffic routed through the network 109. Additionally, in some examples, the functionality of a VPN client can be embedded within the SDK so that a wrapped application can access the VPN tunnel server 117 through a VPN tunnel without needing a VPN client to create the VPN tunnel.

When a library is incorporated into a host application 129, the functionality provided by the library can be invoked by the host management component 126 when executed in the host device 106. For example, if a security library provides the ability to monitor and enable or disable functionality provided by the host application 129, the host management component 126 can call functions provided by the library to monitor and enable or disable the functionality.

The virtual machine execution environment 133 can be an environment in which one or more virtual machines 136 execute in the host device 106. In some examples, the virtual machine execution environment 133 can be a containerized environment. In this regard, the host device 106 can prohibit the transfer of at least some data into and out of the virtual machine execution environment 133. Thus, the operation of components in the virtual machine execution environment 133 can be separate and isolated from other components in the host device 106. Additionally, the virtual machine execution environment 133 can monitor requests or attempts by a user and/or a process executed by a computing device to transmit data in and/or out of a virtual machine, determine whether the communication would be authorized based on compliance rules 119, and allow or block the communication based thereon.

The virtual machine execution environment 133 can include a hypervisor 139 and a virtual machine 136. The virtual machine 136 can be a virtualized computer instance (e.g., image file) that, when executed, can emulate the operation of components of a physical computer. The hypervisor can instantiate and execute the virtual machine 136. In some examples, the hypervisor 139 can also monitor the operation of the virtual machine 136 and provide status information to the host management component 126, the management service 113, and components within the virtual machine 136. Additionally, the hypervisor 139 in some examples can control various components within the virtual machine 136.

In some examples, the hypervisor 139 can be an application that provides an execution platform for one or more virtual machines 146 by providing a containerized environment in which data is allowed to be transmitted to and from a guest operating system when various compliance rules 119 are satisfied. The hypervisor 139 can obtain a package, such as a disk image file, for the virtual machine 136, and install or mount the package to thereby install the virtual machine 136. The hypervisor 139 can also render user interfaces for a guest operating system and cause the user interfaces to be displayed through a user interface within the host operating system 124. Additionally, the hypervisor 139 can intercept hardware calls made by the guest operating system (i.e., executed by a virtual machine) or applications executed thereby, potentially modify or interpret those calls, and relay the calls to the kernel of the host operating system 124. The hypervisor 139 can also control and allocate system resources for the virtual machine 136 based on host operating system 124 instructions and the availability of host device 106 resources (e.g., storage, compute, input/output components). The hypervisor 139 can also function as a communication interface between the virtual machine 146 and components outside of the virtual machine execution environment 133. For example, the hypervisor 139 can receive network traffic from a virtual machine 136 and route or otherwise transmit the network traffic to the network 109 on behalf of the virtual machine 136.

The virtual machine 136 can include a guest operating system 143 and a guest application 149. The guest operating system 143 can manage emulated hardware and software resources for the virtual machine 136. The guest operating system 143 can also provide various services, such as an interprocess communication service that can facilitate various components within the virtual machine 136 communicating with each other.

The guest application 149 can include a set of computer programs that can perform various functionality when executed by the virtual machine 136. For example, the guest application 149 can be a word processing application, a video and image rendering application, or an email client. The user can request to execute and interact with the guest application 149 to perform various functionalities. The guest application 149 can include email clients, development environments, or any other applications that a user might wish to execute on a virtual machine 136. The guest application 149 can further represent applications that are deployed by an administrator to a virtual machine 136 using a virtual machine profile 125.

In some examples, a virtual machine 136 can execute a guest management component, which can monitor activity and settings of components in the virtual machine 136 just as the host management component 126 can manage the host device 106. In addition, the guest management component can monitor activity and settings of components outside of the virtual machine 136. In some examples, the guest management component can parse a data object that describes the states and settings of components associated with the virtual machine 136 to determine whether the compliance rules 119 are violated. In other examples, the guest management component can provide such a data object to the management service 113 or the host management component 126, which they can use to determine whether various components are compliant. The guest management component can also communicate with various components in the host device 106, such as the hypervisor 139, the host management component 126, and host applications 129. For example, the guest management component can communicate with the host management component 126 to inform the host management component 126 of whether the guest management component has determined that various components in the virtual machine 136 are compliant with applicable compliance rules 119.

In some examples, the virtual machine execution environment 133 can be deployed and configured by the management service 113 or the hypervisor management service 115. Further description regarding the deployment and configuration of virtual machine execution environments 133 is provided in U.S. patent application Ser. No. 15/019,193, titled “MANAGED VIRTUAL MACHINE DEPLOYMENT” and filed on Feb. 9, 2016, which is incorporated by reference herein in its entirety.

Virtual machines 136 can be deployed by the management service 113 by providing a virtual machine profile 125 or a disk image that is stored on the host device 106 by the virtual machine execution environment 133 or the host management component 126. In one example, the management service 113 can transmit a virtual machine profile 125 to the virtual machine execution environment 133, which can generate and execute a virtual machine 136 with the properties and capabilities specified by the virtual machine profile 125. As noted above, a particular virtual machine 136 can be bundled with the operating system, applications, and services that are associated with a particular user profile associated with a user (or her device) enrolled with and/or accessing resources provided by the enterprise computing environment 103.

A virtual machine 136 can be associated with an identifier or signature that uniquely identifies the virtual machine 136 with respect to other virtual machines 136 executed in the virtual machine execution environment 133. The signature can be included within a disk image or virtual machine profile 125 that is provided by the management service 113 or hypervisor management service 115 to the virtual machine execution environment 133. The signature can allow the hypervisor 139 to uniquely identify network traffic emanating from a particular virtual machine 136.

The hypervisor 139 can also include or execute a hypervisor management component 151. The hypervisor management component 151 can manage the functionality of the hypervisor 139 on behalf of the hypervisor management service 115. In one example, the hypervisor management component 151 can obtain one or more hypervisor network profiles 153 from the hypervisor management service 115. The hypervisor management service 115 can manage instances of hypervisors 139 that are deployed within virtual machine execution environments 133 deployed to host devices 106. The hypervisor management service 115 can manage hypervisors 139 by providing hypervisor network profiles 153 to a hypervisor 139. In some examples, the hypervisor management service 115 can provide other types of profiles or restrictions that the hypervisor management component 151 can enforce on the hypervisor 139.

A hypervisor network profile 153 can specify authentication or configuration parameters that the hypervisor 139 can use to route network traffic from a virtual machine 136 to the VPN tunnel server 117. The hypervisor 139 can create a tunnel connection to the VPN tunnel server 117 on behalf of a virtual machine 136 without a VPN client needing to be installed or configured on the virtual machine 136. Because the hypervisor 139 acts as a conduit between a virtual machine 136 and the hardware resources of the host device 106, the hypervisor 139 can include logic that encapsulates network traffic from a virtual machine 136 with a security layer consistent with a VPN protocol supported by the VPN tunnel server 117. In other words, the hypervisor 139 can route network traffic from a virtual machine 136 to the VPN tunnel server 117 through a VPN tunnel over the network 109.

In one example, the hypervisor network profile 153 can include an authentication token, or username and password of a particular user of the enterprise. The hypervisor network profile 153 can also include a security certificate with which network traffic can be encrypted and sent to the VPN tunnel server 117. The hypervisor network profile 153 can also specify that network traffic emanating from certain virtual machines 136 deployed by the management service 113 or hypervisor management service 115 with a particular signature or identifier should be routed to the VPN tunnel server 117. In another example, the hypervisor network profile 153 can specify that network traffic destined for a particular network address, such as an internet protocol (IP) address or domain name, should be routed to the VPN tunnel server 117 or transmitted according to a VPN protocol specified by the hypervisor network profile 153.

A hypervisor network profile 153 can also granularly restricted access to the VPN tunnel server 117 such that communications to and/or from particular applications executed by the virtual machine 136, communications to and/or from particular network end-points, and communications containing and/or not containing particular content are routed through the VPN tunnel to the VPN tunnel server 117. To this end, a hypervisor network profile 153 can specify whether one or more of the following should be routed through the VPN tunnel: inbound communications to a particular guest application 149, outbound communications to a particular guest application 149, inbound communications from a particular network end-point, outbound communications to a particular network end-point, communications including particular content, and communications that do not include particular content.

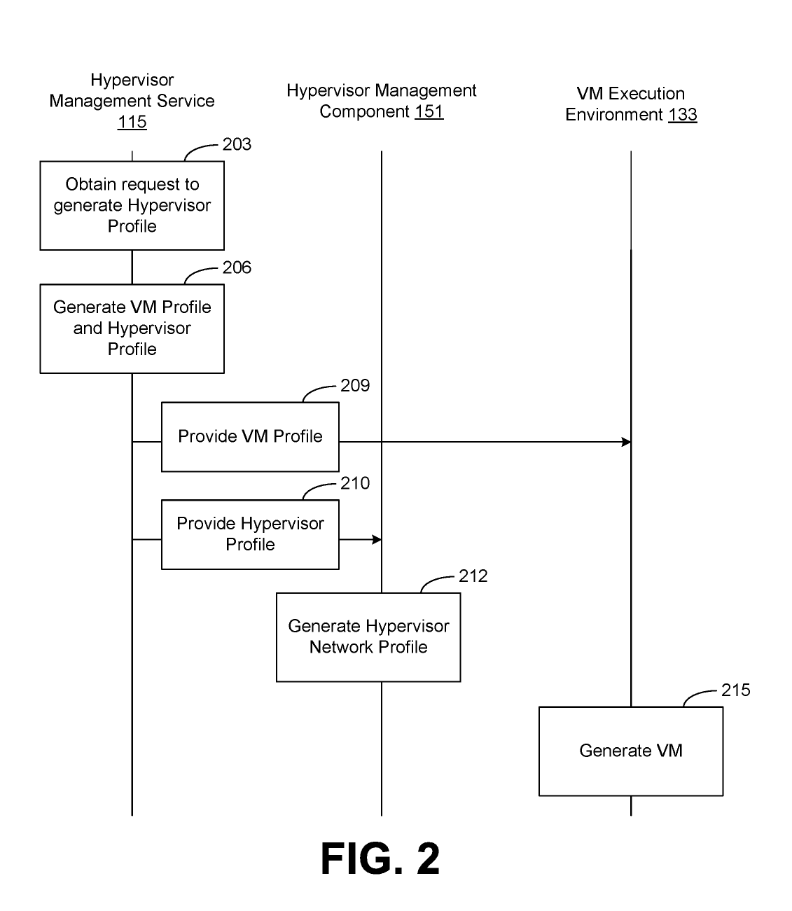

With reference to FIG. 2, shown is a sequence diagram illustrating an example of interactions of components in the networked environment 100. The sequence diagram of FIG. 2 illustrates an example of the hypervisor management service 115 deploying a virtual machine 136 and a hypervisor network profile 153 to a host device 106. In some examples, the depicted functionality can be performed in part or in whole by the management service 113 with respect to a host device 106 that is a managed device.

Starting at step 203, the hypervisor management service 115 can obtain a request to generate a hypervisor profile 121 specifying VPN configuration parameters that specify how a hypervisor 139 should route network traffic from a virtual machine 136 to the network 109 or to the private network 110 through the VPN tunnel server 117. For example, an administrator can utilize a console application (e.g., using a browser) to manipulate a user interface generated by the device management service 113 in which the administrator can define the VPN configuration parameters that should be embedded within a virtual machine profile 125.

Then, at step 206, the hypervisor management service 115 can generate a virtual machine profile 145 on behalf of a user. In one example, a user can navigate to a website or launch a user interface front-end associated with the virtual machine execution environment 133 and enter his or her user credentials. Upon authenticating the user, the hypervisor management service 115 can generate a virtual machine profile 125 for a particular virtual machine 136, which can include information about the operating system, applications and services with which the virtual machine 136 should be provisioned when executed by the virtual machine execution environment 133.

The hypervisor management service 115 can also generate a hypervisor profile 121 corresponding to the virtual machine profile 125. The hypervisor profile 121 can include VPN configuration parameters that specify how the hypervisor 139 can route network traffic from a virtual machine 136 corresponding to the virtual machine profile 125 over the network 109. For instance, the hypervisor profile 121 can specify that traffic destined for a particular network address should be routed to the VPN tunnel server 117. The hypervisor profile 121 can also specify that network traffic originating to or from a particular application should be routed through a VPN tunnel. The VPN configuration parameters embedded within the hypervisor profile 121 can also specify authentication parameters, credentials, or tokens that the hypervisor 139 can utilize to authenticate itself with the VPN tunnel server 117. For example, the hypervisor profile can include or specify a certificate that can be used to authenticate the hypervisor 139 with the VPN tunnel server 117. The hypervisor profile 121 can also identify a particular VPN protocol that should be utilized to create a VPN tunnel connection to the VPN tunnel server 117.

Next, at step 209, the virtual machine profile 145 can be provided to one or both of the hypervisor management component 151 and the virtual machine execution environment 133 on a host device 106 associated with the user. The virtual machine profile 145 can be provided to the virtual machine execution environment 133 by transmitting the virtual machine profile 145 over the network 109. The virtual machine execution environment 133 can receive the virtual machine profile 145 and cause the virtual machine profile 145 to be installed on the host device 106 or within the virtual machine execution environment 133.

Then, at step 210, the hypervisor profile 121 can be provided to the hypervisor management component 151 so that the hypervisor 139 can be configured with the VPN configuration parameters that correspond to the generated virtual machine 136. The hypervisor profile 121 can be provided to the hypervisor management component 151 by transmitting the hypervisor profile 121 over the network 109. The hypervisor management component 121 can receive the hypervisor profile 121 and cause the hypervisor profile 121 to be installed within the hypervisor 139 or within the virtual machine execution environment 133 on the host device 106.

Next, at step 212, the hypervisor management component 151 can generate a hypervisor network profile 153 that is stored in association with the virtual machine execution environment 133. In this way, the hypervisor management service 115 can manage behavior of the hypervisor 139 of the virtual machine execution environment 133 with respect to virtual machines 136 that are deployed on behalf of the enterprise.

Specifically, the hypervisor 139 can carry out particular network routing and encryption without requiring a VPN client be installed on the host device 106 or on the virtual machine 136. In this way, network traffic from a particular virtual machine 136 can be routed to the VPN tunnel server 117 without requiring the user to install, configure, or even authenticate with a VPN client. This can provide the ability for a user to launch a virtual machine 136 and authenticate his or her credentials with a domain controller as if the virtual machine 136 is on the private network 110. The network traffic to the domain controller can be transmitted securely through a VPN tunnel connection to the VPN tunnel server 117 without requiring the user to even launch a VPN client on the host device 106 or within the virtual machine 136.

Finally, at step 215, the virtual machine execution environment 133 can generate the virtual machine 136 on the host device 106, which can in turn be executed by the user. The virtual machine execution environment 133 can generate a virtual machine 136 in a file format that can be executed by the hypervisor 139 within the virtual machine execution environment 133. In some examples, the virtual machine 136 can be embedded within the virtual machine profile 125 as a disk image. In other examples, an executable virtual machine 136 can be created from virtual machine parameters within the virtual machine profile 125. The virtual machine profiles 125 can include authentication credentials of a user or certain applications or services for a particular user or user group.

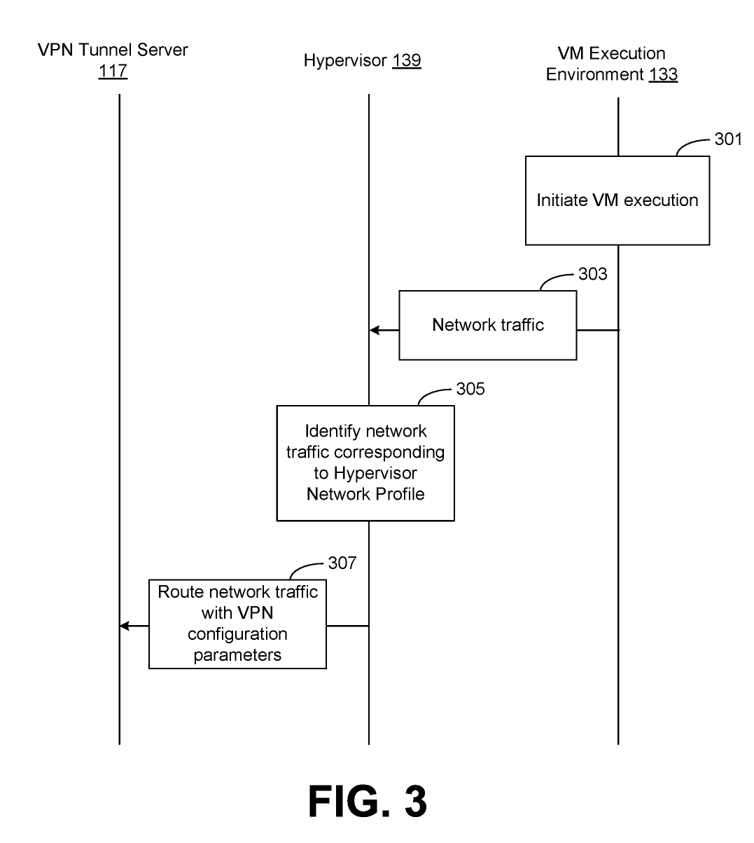

With reference to FIG. 3, shown is a sequence diagram illustrating another example of interactions of components in the networked environment 100. The sequence diagram of FIG. 3 illustrates an example of the hypervisor 139 routing network traffic according to a hypervisor network profile 153.

Beginning with step 301, the virtual machine execution environment 133 can initiate execution of a particular virtual machine 136. As noted above, the virtual machine 136 can have a particular signature or identifier. The virtual machine execution environment 133 can initiate execution of a virtual machine 136 by executing the virtual machine 136 utilizing the hypervisor 139. The hypervisor 139 can in turn provide access to the hardware resources of the host device 106 on behalf of the virtual machine 136. In this way, from a user point-of-view, the virtual machine 136 represents a distinct computing environment that is executed on the host device 106.

At step 303, the virtual machine 136 can direct network traffic to the hypervisor 139. As with all virtual machines 136 executed within the virtual machine execution environment 133, the hypervisor 139 can handle requests to interact with the physical resources of the host device 106. For instance, the physical resources of the host machine 106 can include a network interface used to access the network 109. Therefore, as the virtual machine 136 generates network traffic, the hypervisor 139 can route the network traffic generating by applications within the virtual machine 136 to the network 109.

At step 305, the hypervisor 139 can identify that the network traffic is being transmitted by a virtual machine 136 that corresponds to hypervisor network profile 153 that specifies that the network traffic should be routed through a VPN tunnel connection over the network 109 to the VPN tunnel server 117. In one example, the hypervisor network profile 153 can specify that traffic destined for a particular network address should be routed to the VPN tunnel server 117. Accordingly, the hypervisor 139 can identify network traffic destined for the particular network address. The hypervisor network profile 153 can also specify that network traffic originating from a particular application should be routed through a VPN tunnel. Accordingly, the hypervisor 139 can identify network traffic sent from the particular application specified by the hypervisor network profile 153. The application can be identified by the hypervisor network profile 153 by an application or package identifier.

At step 307, the hypervisor 139 can route the network traffic, encapsulate the network traffic with a security layer, or otherwise cause the network traffic to be sent through a VPN tunnel connection to the VPN tunnel server 117. The hypervisor 139 can route the network traffic to the VPN tunnel server 117 using the VPN configuration parameters from the hypervisor network profile 153 deployed by the hypervisor management service 115. In this way, network traffic is securely routed to the VPN tunnel server 117. Should access of the virtual machine 136 to the VPN tunnel server 117 be revoked, the hypervisor management service 115 can send a command to the hypervisor 139 instructing the hypervisor 139 to remove the hypervisor network profile 153 or invalidate the credentials of the user or virtual machine 136 or an authentication token that are embedded within the hypervisor network profile 153. In one example, access to the VPN tunnel server 117 can be revoked by an administrator of the VPN tunnel server 117 by invalidating the authentication credentials, authentication token, or certificate used by the hypervisor 139 to access the VPN tunnel server 117.

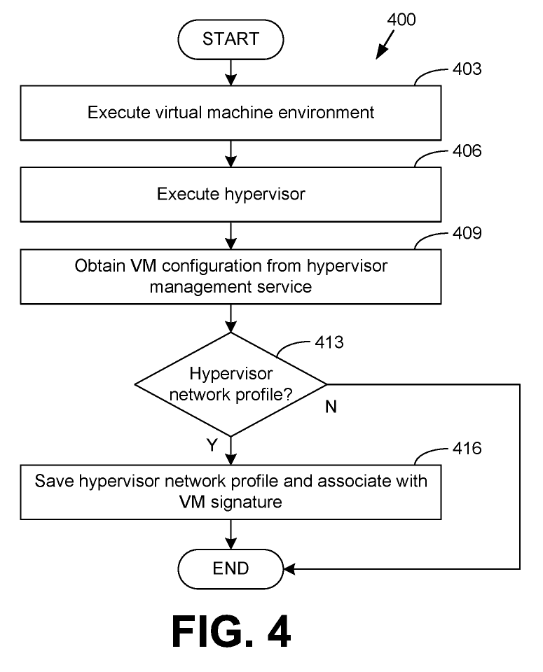

With reference to FIG. 4, shown is a flowchart that provides a method 400 according to various examples. In particular, FIG. 4 provides an example of how a hypervisor management service 115 can provision a virtual machine 136 and a hypervisor network profile 153 to a host device 106.

Beginning with step 403, the host device 106 can execute a virtual machine execution environment 133. The virtual machine execution environment 133 can be deployed by the management service 113 or installed by a user onto the host device 106. In one example, the management service 113 can instruct the host device 106 to execute the virtual machine execution environment 133, such as by placing a command in a command queue associated with the host device 106 provided by the management service 113 which can be retrieved by a host management component 126.

Next, at step 406, the host device 106 can execute the hypervisor 139. The hypervisor 139 can be executed by the virtual machine execution environment 133. The virtual machine execution environment 133 can execute the hypervisor 139 so that virtual machines 136 that are deployed onto a host device 106 and executed within the virtual machine execution environment 133 can access the physical resources of the host device 106.

Then, at step 409, the hypervisor management component 151 can obtain a virtual machine configuration from the hypervisor management service 115. In one example, a virtual machine configuration can include a virtual machine profile 125 as well as a hypervisor profile 121. The virtual machine profile 125 and hypervisor profile 121 can deployed to the hypervisor management component 151 by placing a command in a command queue associated with the host device 106. The command queue can be provided by the hypervisor management service 115 and retrieved by the hypervisor management component 151.

At step 413, the hypervisor management component 151 can determine whether hypervisor profile 121 is associated with a hypervisor network profile 153. The hypervisor network profile 153 can specify how network traffic from a particular virtual machine 136 should be routed according to a VPN configuration. If there are no hypervisor network profiles 153 associated with the hypervisor profile 121, the process can proceed to completion.

If there are one or more hypervisor network profiles 153 associated with the hypervisor profile 121, at step 416, the hypervisor management component 151 can associate a hypervisor network profile 153 with a particular virtual machine 136 accessible to the host device 106. The hypervisor network profile 153 can specify that certain network traffic from a certain virtual machine 136 should be routed to the public Internet and that other traffic should be routed through a VPN tunnel to a VPN tunnel server 117. The hypervisor network profile 153 can also specify that network traffic from a particular application executed by a virtual machine 136 should be routed through the VPN tunnel to the VPN tunnel server 117. The hypervisor network profile 153 can further specify that network traffic containing particular data or particular types of data should be routed through the VPN tunnel to the VPN tunnel server 117. The network traffic can be identified by domain name, from a particular application on the virtual machine 136, or by IP address. The hypervisor network profile 153 can also specify that all traffic from a certain virtual machine 136 should be routed through a VPN tunnel to a VPN tunnel server 117. Thereafter, the process can proceed to completion.

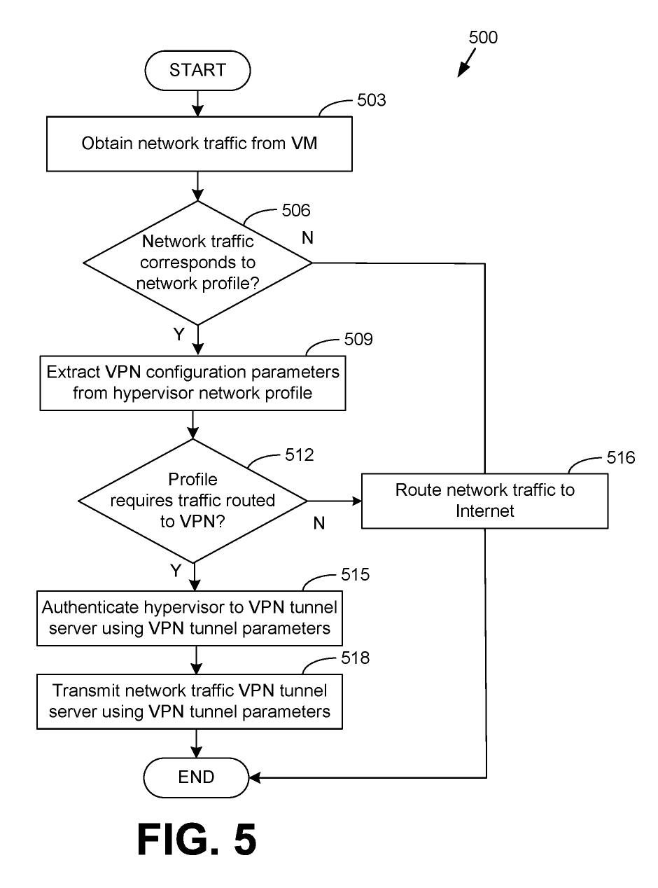

With reference to FIG. 5, shown is a flowchart that provides a method 500 according to various examples. In particular, FIG. 5 provides an example of how a hypervisor 139 can route network traffic from a virtual machine 136 according to a hypervisor network profile 153.

Beginning with step 503, the hypervisor 139 can obtain network traffic from a virtual machine 136 provisioned to and executed by the virtual machine execution environment 133. The virtual machine 136 can be provisioned by the management service 113 or hypervisor management service 115 to a host device 106 on behalf of an enterprise. In one scenario, the host device 106 is a managed device. In other scenarios, the virtual machine execution environment 133 or just the hypervisor 139 can be managed by a remotely executed hypervisor management service 115 or any other service that only manages certain components executed on the host device 106. The network traffic can be transmitted to or from an application executed by the virtual machine 136.

At step 506, the hypervisor 139 can determine whether the network traffic is transmitted to or from a virtual machine 136 having a signature or identifier for which a hypervisor network profile 153 has been saved on the host device 106. If no hypervisor network profile 153 exists for the virtual machine 136 or if no particular routing instructions are specified by a hypervisor network profile 153, the process can proceed to step 516, where the network traffic is routed by the hypervisor 139 to the public Internet or to the network 109.

The hypervisor 139 can identify network traffic associated with a hypervisor network profile 153 by determining that the hypervisor network profile 153 identifies that network traffic by specifying a particular virtual machine 136 signature. The hypervisor network profile 153 can also identify particular network by identifying a particular network endpoint to which network traffic is directed. Additionally, the hypervisor network profile 153 can identify network traffic by specifying a particular application that is executed within a virtual machine 136. If the network traffic is not associated with a particular hypervisor network profile 153, the process can proceed to step 516. At step 516, the network traffic is routed by the hypervisor 139 to the public Internet, or the network 109. Otherwise, the process proceeds to step 509.

At step 509, the hypervisor 139 can extract VPN configuration parameters from the hypervisor network profile 153. The VPN configuration parameters can specify whether certain or all network traffic from a particular virtual machine 136 should be routed to a VPN tunnel server 117 that provides access to a private network 110. The VPN configuration parameters can specify whether certain or all network traffic sent to or from a particular network endpoint should be routed to a VPN tunnel server 117. Additionally, the VPN configuration parameters can specify whether certain or all network traffic sent to or from a particular application should be routed to a VPN tunnel server 117.

The process can then proceed to step 512. At step 512, the hypervisor 139 can determine whether the hypervisor network profile 153 specifies that the network traffic should be routed to a VPN tunnel server 117 or through the public Internet. The hypervisor network profile 153 can specify that traffic emanating from a particular application or with a particular domain name, IP address, or IP address range, should be routed to the VPN tunnel server 117 using a particular VPN protocol. The hypervisor network profile 153 can also specify authentication parameters or a certificate with which the network traffic should be encrypted. If the hypervisor network profile 153 does not specify that the network traffic should be routed to the VPN tunnel server 117, the process can proceed from step 512 to 516, where the network traffic is routed by the hypervisor 139 to the public Internet, or the network 109.

If the hypervisor network profile 153 does specify that the network traffic should be routed to a particular VPN tunnel server 117, the process can proceed from step 512 to step 515, where the hypervisor can authenticate with the VPN tunnel server 117 using the VPN configuration parameters extracted from the hypervisor network profile 153.

Next, at step 518, the hypervisor 139 can transmit the network traffic to the VPN tunnel server 117 by establishing a VPN tunnel using the VPN configuration parameters from the hypervisor network profile 153. The VPN tunnel can be established between the hypervisor 139 and the VPN tunnel server 117 using a VPN protocol specified by the hypervisor network profile 153. The VPN tunnel can be secured using authentication credentials, authentication token, or a certificate extracted from the hypervisor network profile 153. Upon establishing the VPN tunnel, the hypervisor 139 can route the network traffic obtained from the virtual machine 136 at step 503 to the VPN tunnel server 117 through the VPN tunnel. Thereafter, the process can proceed to completion.

The sequence diagrams and flowcharts discussed above show examples of the functionality and operation of implementations of components described herein. The components of the networked environment 100 described herein can be embodied in hardware, software, or a combination of hardware and software. If embodied in software, each step in the sequence diagrams and flowcharts can represent a module or a portion of code that includes computer instructions to implement the specified logical functions. The computer instructions can include source code that comprises human-readable statements written in a programming language or machine code that comprises machine instructions recognizable by a suitable execution system, such as a processor in a computer system. If embodied in hardware, each step can represent a circuit or a number of interconnected circuits that implement the specified logical functions.

Although the sequence diagrams and flowcharts discussed above show a specific order of execution, the order of execution can differ from that which is shown. For example, the order of execution of two or more steps can be switched relative to the order shown. Also, two or more steps shown in succession can be executed concurrently or with partial concurrence. Further, in some examples, one or more of the steps shown in the flowcharts can be skipped or omitted. In addition, any number of counters, state variables, warning semaphores, or messages can be added to the logical flow described herein, for purposes of enhanced utility, accounting, performance measurement, or troubleshooting aid.

The enterprise computing environment 103 and host device 106 can include at least one processing circuit. Such a processing circuit can include one or more processors and one or more storage devices that are coupled to a local interface. The local interface can include a data bus with an accompanying address/control bus.

A storage device for a processing circuit can store data and components that are executable by the one or more processors of the processing circuit. In some examples, at least portions of the management service 113, the host operating system 124, the host management component 126, the host application 129, and the hypervisor 139 can be stored in one or more storage devices and be executable by one or more processors. Also, the enterprise data store 116 can be located in the one or more storage devices.

Components described herein can be embodied in the form of hardware, as software components that are executable by hardware, or as a combination of software and hardware. If embodied as hardware, the components described herein can be implemented as a circuit or state machine that employs any suitable hardware technology. Such hardware technology includes, for example, microprocessors, discrete logic circuits having logic gates for implementing various logic functions upon an application of one or more data signals, application specific integrated circuits (ASICs) having appropriate logic gates, or programmable logic devices, such as field-programmable gate array (FPGAs) and complex programmable logic devices (CPLDs).

Also, one or more or more of the components described herein that include software or computer instructions can be embodied in any non-transitory computer-readable medium for use by or in connection with an instruction execution system such as, for example, a processor in a computer system or other system. Such a computer-readable medium can contain, store, and maintain the software and computer instructions for use by or in connection with the instruction execution system.

A computer-readable medium can comprise a physical media, such as magnetic, optical, semiconductor, or other suitable media. Examples of a suitable computer-readable media include solid-state drives, magnetic drives, flash memory, and storage discs, such as compact discs (CDs). Further, any logic or component described herein can be implemented and structured in a variety of ways. For example, one or more components described can be implemented as modules or components of a single application. Additionally, one or more components described herein can be executed in one computing device or by using multiple computing devices.

The examples described above are merely examples of implementations to set forth for a clear understanding of the principles of the disclosure. Many variations and modifications can be made to the examples described above without departing substantially from the spirit and principles of the disclosure. All such modifications and variations are intended to be included herein within the scope of this disclosure.

Therefore, the following is claimed:

1. A method, comprising:
causing a virtual machine execution environment to be executed by a host device, wherein the virtual machine execution environment comprises a hypervisor and a hypervisor management component, the hypervisor management component configured to communicate with a hypervisor management service over a network connection;
causing a first virtual machine to be executed within the virtual machine execution environment;
identifying a hypervisor network profile associated with the hypervisor management service, the hypervisor network profile specifying a first network configuration for the first virtual machine, the first network configuration specifying configuration properties for a virtual private network (VPN) tunnel connection; and
routing network traffic associated with the first virtual machine through the VPN tunnel connection.

2. The method of claim 1, wherein the hypervisor network profile specifies authentication parameters for the VPN tunnel connection.

3. The method of claim 2, wherein the authentication parameters comprise at least one of an authentication token, a username, a password, or a security certificate.

4. The method of claim 1, wherein the hypervisor network profile specifies a VPN tunnel server through which the network traffic should be routed onto a private network.

5. The method of claim 1, wherein the hypervisor network profile specifies that network traffic associated with a particular network address should be routed through the VPN tunnel connection and that network traffic associated with a network address that is not the particular network address should be routed to the public Internet.

6. The method of claim 1, wherein executing the first virtual machine within the virtual machine execution environment further comprises generating the first virtual machine from a first virtual machine configuration associated with the hypervisor management service.

7. The method of claim 1, wherein routing network traffic from the first virtual machine through the VPN tunnel connection further comprises identifying the network traffic from the first virtual machine based upon a signature associated with the first virtual machine.

8. A system, comprising:
a host device comprising a virtual machine execution environment, wherein the virtual machine execution environment comprises a hypervisor and a virtual machine;
a storage device storing a plurality of computer instructions executable by the host device, wherein the plurality of computer instructions cause the host device to at least:
cause a virtual machine execution environment to be executed by a host device, wherein the virtual machine execution environment comprises a hypervisor and a hypervisor management component, the hypervisor management component configured to communicate with a hypervisor management service over a network connection;
cause a first virtual machine to be executed within the virtual machine execution environment;
identify a hypervisor network profile associated with the hypervisor management service, the hypervisor network profile specifying a first network configuration for the first virtual machine, the first network configuration specifying configuration properties for a virtual private network (VPN) tunnel connection; and
route network traffic associated with the first virtual machine through the VPN tunnel connection.

9. The system of claim 8, wherein the hypervisor network profile specifies authentication parameters for the VPN tunnel connection.

10. The system of claim 9, wherein the authentication parameters comprise at least one of an authentication token, a username, a password, or a security certificate.

11. The system of claim 8, wherein the hypervisor network profile specifies a VPN tunnel server through which the network traffic should be routed onto a private network.

12. The system of claim 8, wherein the hypervisor network profile specifies that network traffic associated with a particular network address should be routed through the VPN tunnel connection and that other network traffic associated with a network address that is not the particular network address should be routed to the public Internet.

13. The system of claim 8, wherein the first virtual machine is executed within the virtual machine execution environment, the plurality of computer constructions further causes the at least one computing device to at least generate the first virtual machine from a first virtual machine configuration associated with the hypervisor management service.

14. The system of claim 8, wherein network traffic is routed from the first virtual machine through the VPN tunnel connection further comprises identifying the network traffic from the first virtual machine based upon a signature associated with the first virtual machine.

15. A non-transitory computer-readable medium storing a plurality of computer instructions executable by a host device, wherein the host device comprises a virtual machine execution environment that comprises a hypervisor and a virtual machine, wherein the plurality of computer instructions cause the host device to at least:
cause a virtual machine execution environment to be executed by a host device, wherein the virtual machine execution environment comprises a hypervisor and a hypervisor management component, the hypervisor management component configured to communicate with a hypervisor management service over a network connection;
cause a first virtual machine to be executed within the virtual machine execution environment;
identify a hypervisor network profile associated with the hypervisor management service, the hypervisor network profile specifying a first network configuration for the first virtual machine, the first network configuration specifying configuration properties for a virtual private network (VPN) tunnel connection; and
route network traffic associated with the first virtual machine through the VPN tunnel connection.

16. The non-transitory computer-readable medium of claim 15, wherein the hypervisor network profile specifies authentication parameters for the VPN tunnel connection.

17. The non-transitory computer-readable medium of claim 15, wherein the hypervisor network profile specifies a VPN tunnel server through which the network traffic should be routed onto a private network.

18. The non-transitory computer-readable medium of claim 15, wherein the hypervisor network profile specifies that network traffic associated with a particular network address should be routed through the VPN tunnel connection and that other network traffic associated with a network address that is not the particular network address should be routed to the public Internet.

19. The non-transitory computer-readable medium of claim 15, wherein the first virtual machine is executed within the virtual machine execution environment, the plurality of computer instructions further causing the host device to at least generate the first virtual machine from a first virtual machine configuration associated with the hypervisor management service, transmitted to.

20. The non-transitory computer-readable medium of claim 15, wherein network traffic is routed from the first virtual machine through the VPN tunnel connection, the plurality of computer instructions further causing the host device to identify the network traffic from the first virtual machine based upon a signature associated with the first virtual machine.
